(19) United States
(12) Patent Application Publication
(10) Pub. No.: US 2021/0065374 A1
(43) Pub. Date: Mar. 4, 2021

(54) SYSTEM AND METHOD FOR EXTRACTING OUTLINES OF PHYSICAL OBJECTS

(71) Applicant: Organize Everything Inc., Escondido, CA (US)

(72) Inventor: Marko Mandaric, Escondido, CA (US)

(21) Appl. No.: 17/003,641

(22) Filed: Aug. 26, 2020

Related U.S. Application Data
(60) Provisional application No. 62/891,666, filed on Aug. 26, 2019.

(51) Int. Cl. G06T 7/13; H04N 5/232; G06K 19/06

(52) U.S. Cl. CPC G06T 7/13; G06K 19/06037; H04N 5/23222

(57) ABSTRACT

A method is disclosed. The method includes imaging an object and an environment in which the object is located, identifying a high contrast area at an edge of the object, isolating a contour of the object based on the high contrast area, determining a scale of the environment, and determining a dimension of the contour based on the scale.

### CROSS-REFERENCE TO RELATED APPLICATIONS

This application claims priority to U.S. provisional patent application 62/891,666 filed on Aug. 26, 2019, and entitled “SYSTEM AND METHOD FOR EXTRACTING OUTLINES OF PHYSICAL OBJECTS,” the entire disclosure of which is incorporated herein by reference.

### TECHNICAL FIELD

The present disclosure is directed to a system and method for extracting outlines, and more particularly, to a system and method for extracting outlines of physical objects.

### BACKGROUND OF THE DISCLOSURE

Conventional systems for extracting outlines of physical objects typically do not allow for accurate capture of physical objects. For example, conventional systems include defects, for example, associated with barrel roll and distortion. Also, conventional systems typically cannot accurately estimate a real-world scale of an object.

The exemplary disclosed system and method of the present disclosure is directed to overcoming one or more of the shortcomings set forth above and/or other deficiencies in existing technology.

### SUMMARY OF THE DISCLOSURE

In one exemplary aspect, the present disclosure is directed to a method. The method includes imaging an object and an environment in which the object is located, identifying a high contrast area at an edge of the object, isolating a contour of the object based on the high contrast area, determining a scale of the environment, and determining a dimension of the contour based on the scale.

In another aspect, the present disclosure is directed to a system. The system includes an object outlining module, comprising computer-executable code stored in non-volatile memory, a processor, and a user device including an imaging device. The object outlining module, the processor, and the user device are configured to image an object and an environment in which the object is located, identify a high contrast area at an edge of the object, isolate an edge contour of the object based on the high contrast area, determine a scale of the environment, and determine a dimension of the edge contour based on the scale

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a front illustration of at least some exemplary embodiments of the present disclosure;

FIG. 2 is a front illustration of at least some exemplary embodiments of the present disclosure;

FIG. 3 is a front illustration of at least some exemplary embodiments of the present disclosure;

FIG. 4 is a front illustration of at least some exemplary embodiments of the present disclosure;

FIG. 5 is a front illustration of at least some exemplary embodiments of the present disclosure;

FIG. 6 is a front illustration of at least some exemplary embodiments of the present disclosure;

FIG. 7 is a front illustration of at least some exemplary embodiments of the present disclosure;

FIG. 8 is a front illustration of at least some exemplary embodiments of the present disclosure;

FIG. 9 is a front illustration of at least some exemplary embodiments of the present disclosure;

FIG. 10 is a front illustration of at least some exemplary embodiments of the present disclosure;

FIG. 11 is a front illustration of at least some exemplary embodiments of the present disclosure;

FIG. 12 is a front illustration of at least some exemplary embodiments of the present disclosure;

FIG. 13 is a front illustration of at least some exemplary embodiments of the present disclosure;

FIG. 14 illustrates an exemplary process of at least some exemplary embodiments of the present disclosure;

FIG. 15 is a schematic illustration of an exemplary computing device, in accordance with at least some exemplary embodiments of the present disclosure;

FIG. 16 is a schematic illustration of an exemplary network, in accordance with at least some exemplary embodiments of the present disclosure; and

FIG. 17 is a schematic illustration of an exemplary network, in accordance with at least some exemplary embodiments of the present disclosure.

### DETAILED DESCRIPTION AND INDUSTRIAL APPLICABILITY

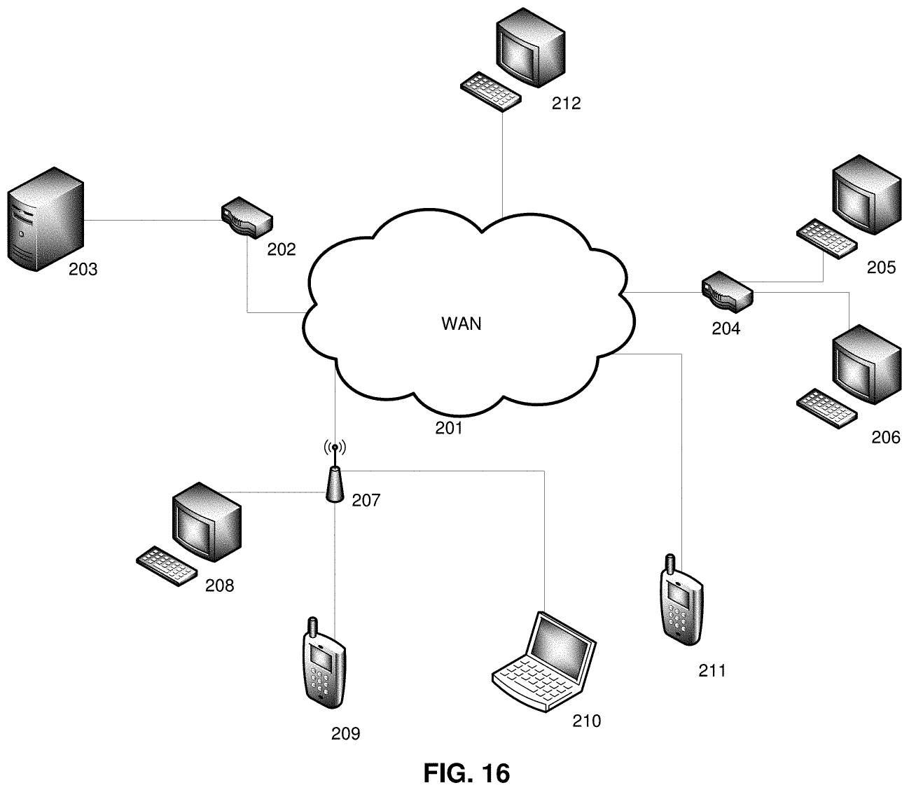

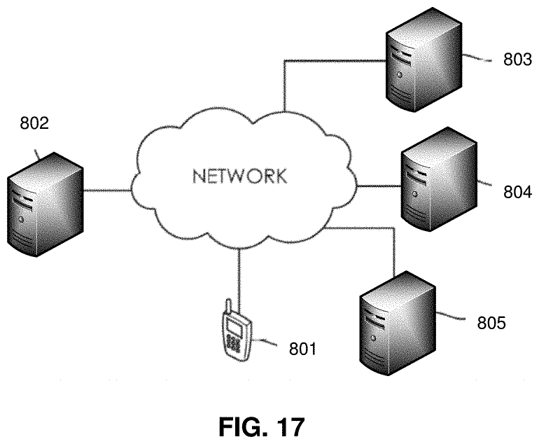

The exemplary disclosed system may be a system for extracting outlines of physical objects, scaled to real-world proportions. System 300 may include a user device 305. User device 305 may be communicate with other components of system 300 by any suitable technique such as via a network similar to the exemplary disclosed networks described below regarding FIGS. 16 and 17. The exemplary disclosed components may communicate via wireless communication (e.g., CDMA, GSM, 3G, 4G, and/or 5G), direct communication (e.g., wire communication), Bluetooth communication coverage, Near Field Communication (e.g., NFC contactless communication), radio frequency communication (e.g., RF communication such as short-wavelength radio waves, e.g., UHF waves), and/or any other desired communication technique.

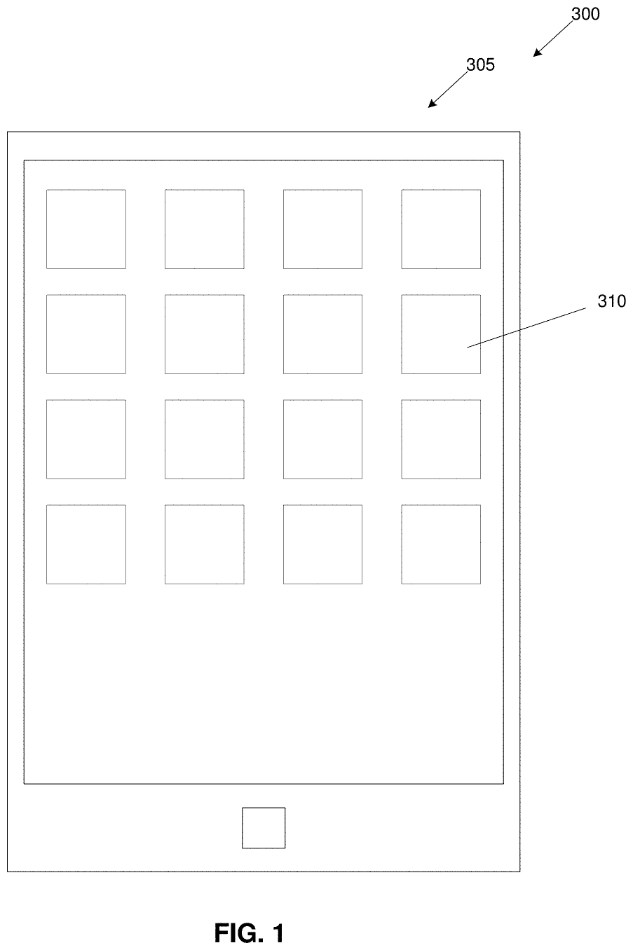

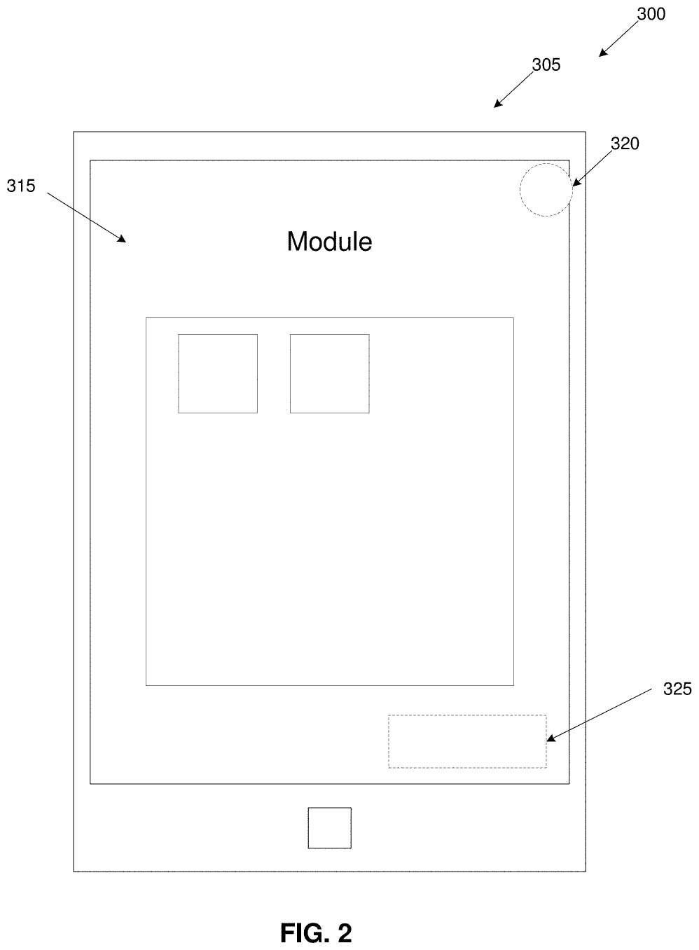

User device 305 may be any suitable user device for receiving input and/or providing output (e.g., raw data or other desired information) to a user. User device 305 may be or may include an imaging system for example as described below. User device 305 may be, for example, a touchscreen device (e.g., a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user device or interface designed to work specifically with other components of system 300, and/or any other suitable user device or interface. For example, user device 305 may include a touchscreen device of a smartphone or handheld tablet. For example, user device 305 may include a display that may include a graphical user interface to facilitate entry of input by a user and/or receiving output. For example, system 300 may provide notifications to a user via output transmitted to user device 305. User device 305 may also be any suitable accessory such as a smart watch, Bluetooth headphones, and/or other suitable devices that may communicate with components of system 300. In at least some exemplary embodiments, user device 305 may be a mobile phone or tablet such as a smartphone or a smart tablet as illustrated in FIGS. 1 and 2. For example, user device 305 may include a plurality of applications 310 that may be displayed on a screen or any other suitable graphical user interface of user device 305.

User device 305 may include an imaging system 320. Imaging system 320 may include any suitable device for collecting image data such as, for example, a camera system (e.g., an image camera and/or video camera system). For example, imaging system 320 may be the camera of user device 305 that may be a smartphone. Imaging system 320 may be a camera that provides high contrast characteristics of a captured image and/or video feed to system 300. Imaging system 320 may also include a laser device and a sensor that may use the laser device to illuminate a target object with laser light and then measure a reflection of the laser with a sensor. Imaging system 320 may include a 3-D laser scanning device. For example, imaging system 320 may include a LIDAR camera. For example, imaging system 320 may be a LIDAR camera that may utilize ToF (Time of Flight) lasers to build a 3-D representation of the object (e.g., object 318) being captured (e.g., from which system 300 may extract an outline as viewed from above or any desired side, or may build a full 3-D model to be used as a cavity in a more complex 3-D foam enclosure). In at least some exemplary embodiments, imaging system 320 may be disposed on or at a back or rear side of user device 305 (e.g., at a backside of user device 305 that may be a smartphone). Imaging system 320 may be integrated into user device 305 and may capture video footage, still imagery, and/or 3-D image data of an object (e.g., including a physical object). For example, a user may position a physical object within a field of view (FOV) of an exemplary disclosed device of imaging system 320. In at least some exemplary embodiments, system 300 may operate using computer vision software that works with data collected by imaging system 320.

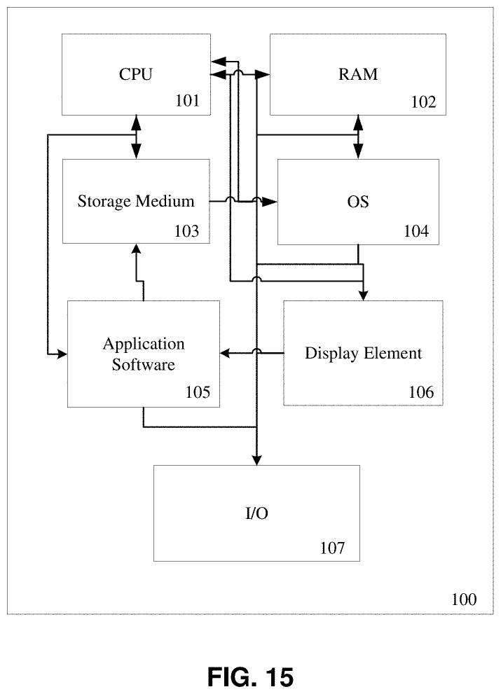

System 300 may include one or more modules for example as disclosed herein. For example, system 300 may include an object outlining module (e.g., a module 315) for example as described herein. The exemplary disclosed modules may be partially or substantially entirely integrated with one or more components of system 300. The one or more modules may be software modules as described for example below regarding FIG. 15. For example, the one or more modules may include computer-executable code stored in non-volatile memory. The one or more modules may also operate using a processor (e.g., as described for example herein). The one or more modules may store data and/or be used to control some or all of the exemplary disclosed processes described herein.

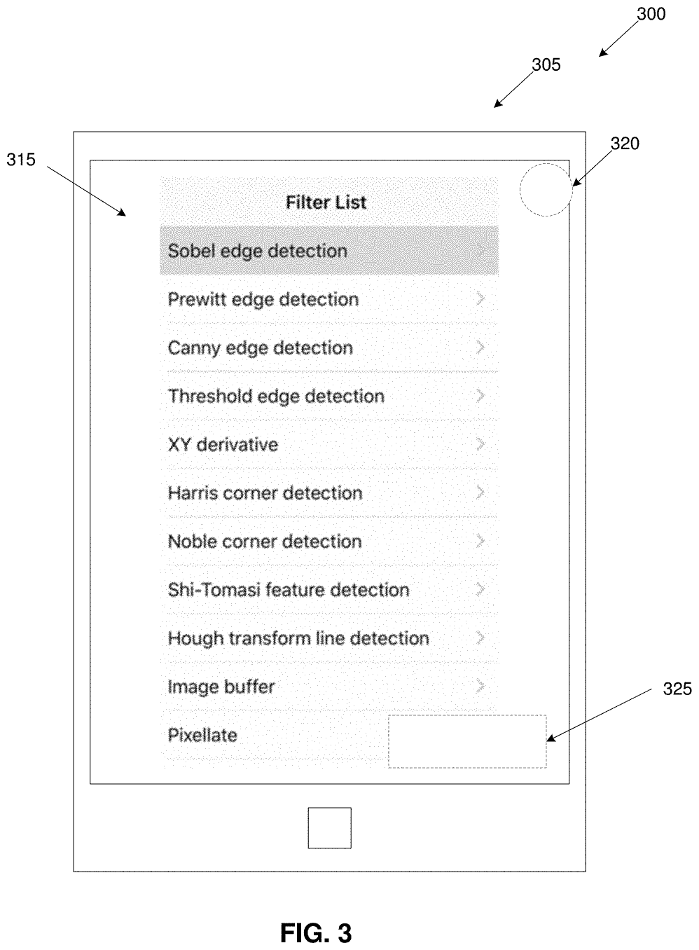

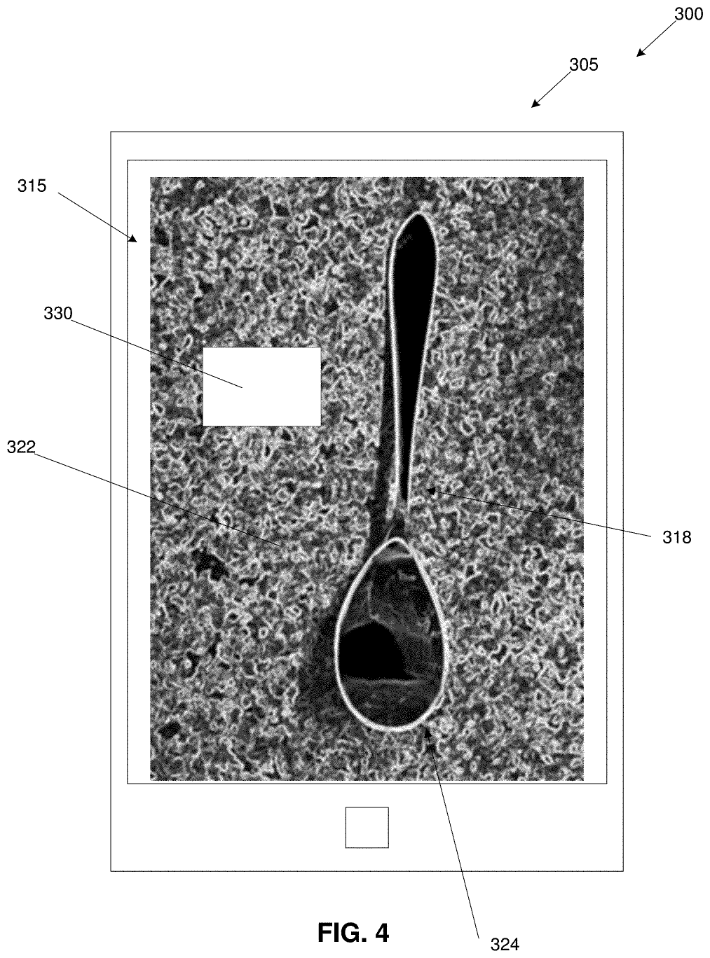

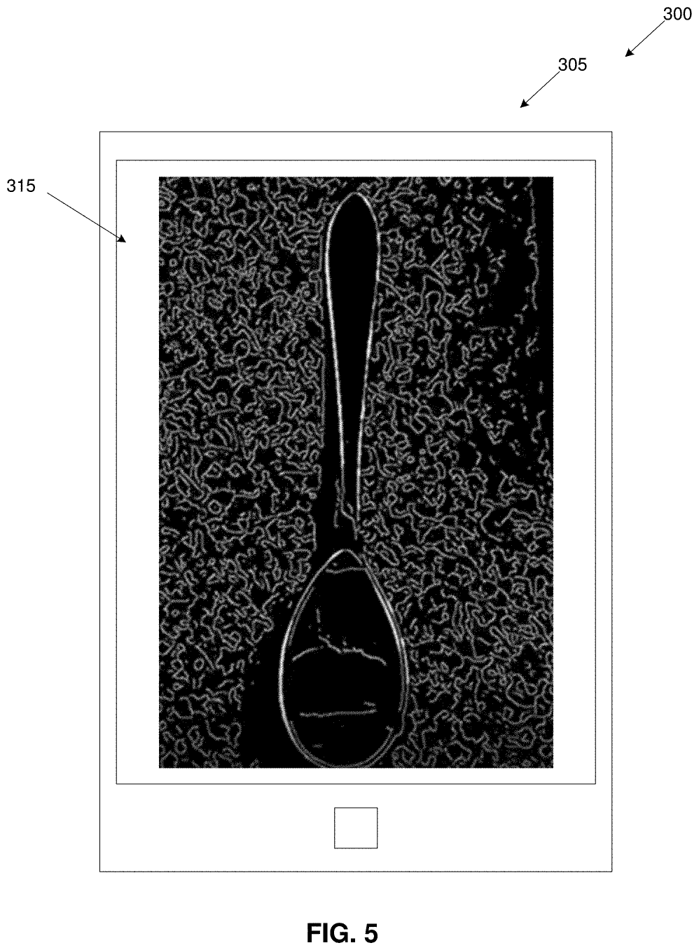

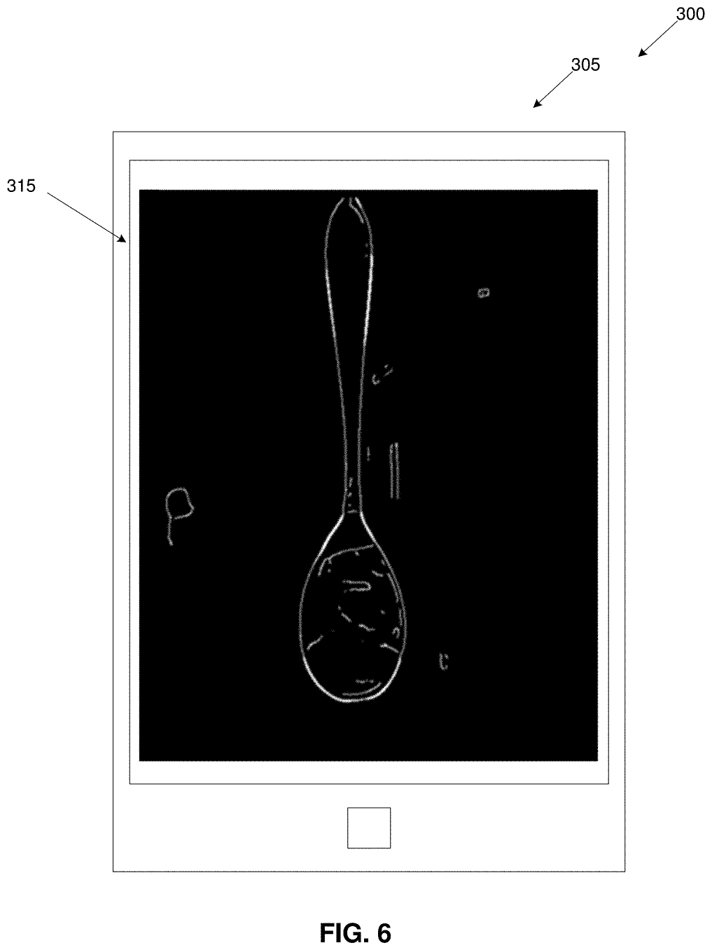

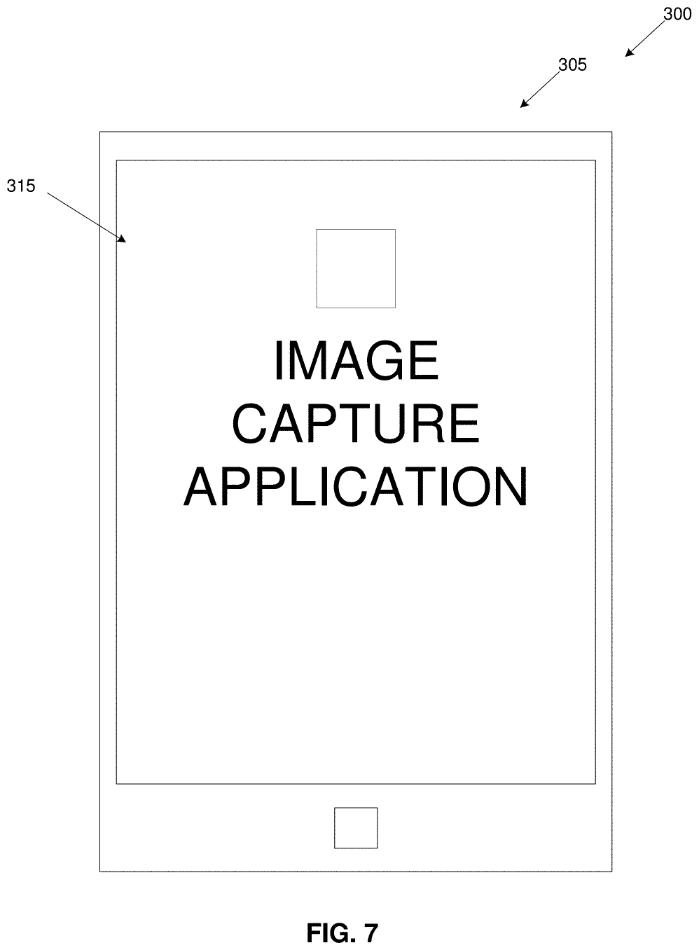

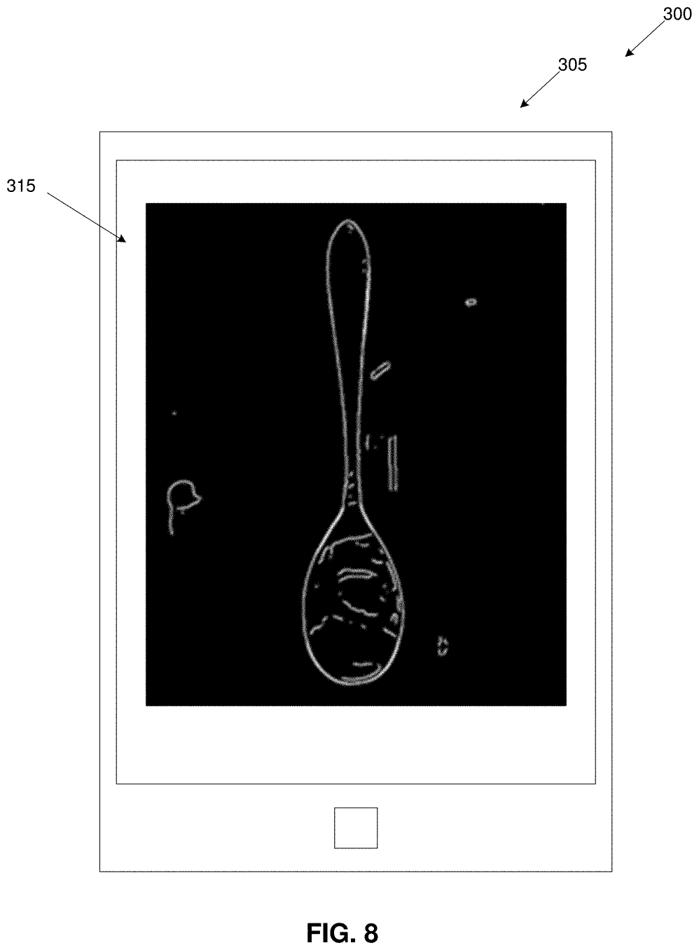

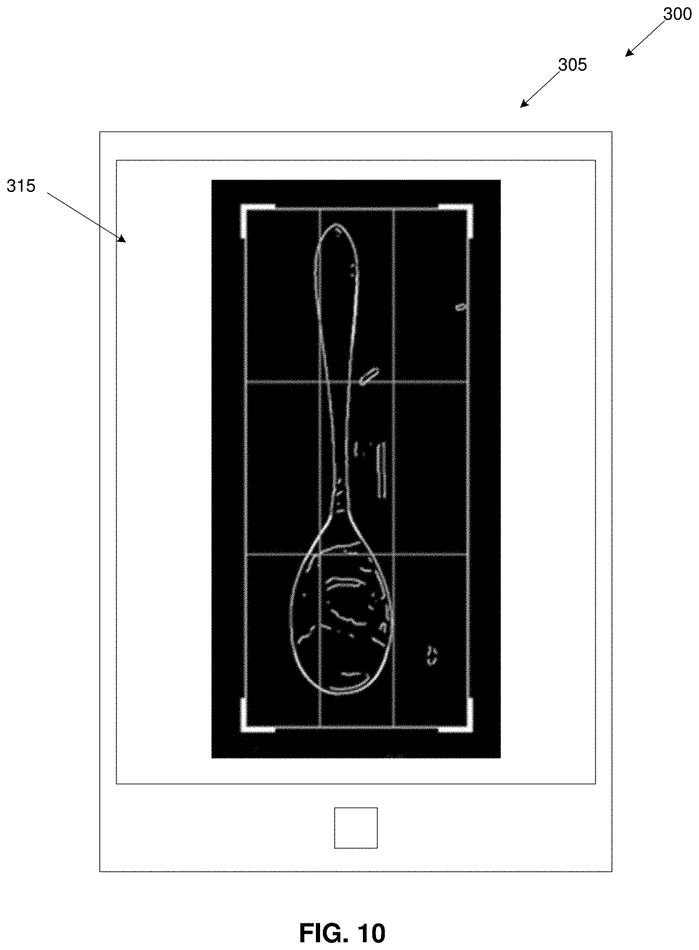

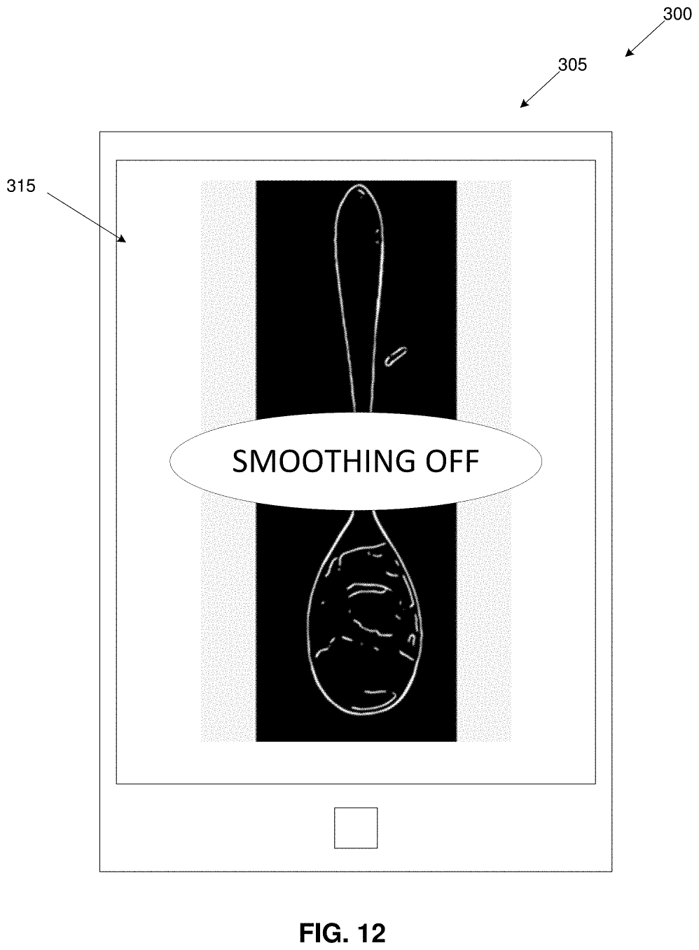

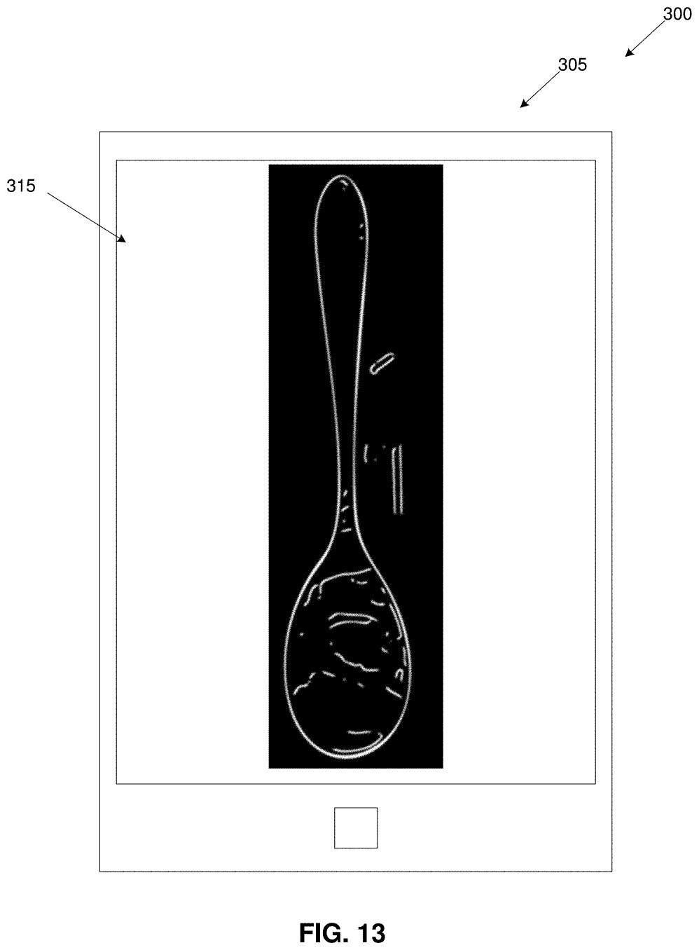

System 300 may include an edge detection module that may include and execute an edge detection algorithm (e.g., module 315). For example as illustrated in FIGS. 2 and 3, system 300 may include and display module 315. Module 315 may include an edge detection module or algorithm such as Canny (e.g., Canny edge detector) and/or Sobel (e.g., Sobel operator or Sobel filter). In at least some exemplary embodiments, OpenCV may be used for extracting edges from an image and/or video feed provided by imaging system 320. The edge detection module or algorithm may identify high contrast areas such as those associated with an object (e.g., object 318 as illustrated in FIG. 4) being imaged or targeted by imaging system 320. For example, the edge detection module or algorithm may identify high contrast areas found at the edges of an object (e.g., being imaged or targeted by imaging system 320) and a surface (e.g., a surface 322) captured behind the object. The edge detection module or algorithm may determine (e.g., produce and output) graphical approximations of these high contrast interactions. System 300 may perform post-processing of the initial derived data (e.g., data of the edges) to isolate a largest edge of an object (e.g., a largest edge or contour of an object such as a silhouette of the object being imaged or targeted by imaging system 320 and the exemplary disclosed edge detection module or algorithm). For example, system 300 may isolate a contour (e.g., a contour or edge contour such as edge contour 324) of the object. For example, FIG. 4 illustrates an exemplary operation of a Sobel edge detection module or algorithm. Also for example, FIGS. 5-13 illustrate an exemplary operation of a Canny edge detection module or algorithm.

System 300 may include a scale module (e.g., module 315) or scale system. The scale module or system may determine a scale (e.g., a real-world scale) of a captured environment (e.g., in which the object is disposed). For example, the scale module or system may determine a scale (e.g., a real-world scale) of a captured environment (e.g., including an object such as object 318) by using a visual reference object 330 (e.g., an item such as a checkpoint) of a predetermined size (e.g., known size) that is imaged (e.g., captured) within the field of view (e.g., initial field of view) when imaging the physical object for example as illustrated in FIG. 4. System 300 may determine a scale of the imaged environment by basing the scale on the imaged visual reference object (e.g., visual reference object 330). For example, visual reference object 330 may be disposed in a field of view of imaging system 320 when object 318 is being imaged by imaging system 320 (e.g., a camera). For example, visual reference object 330 may be a printed two-dimensional bar code (e.g., a QR code printed on a piece of plastic or paper such as a business-card-sized piece of plastic or paper or piece of material of any desired or suitable size or shape). Also for example, visual reference object 330 may be a physical coin (e.g., a U.S. quarter) or other common item or object (e.g., having a known size) that may serve as a suitable reference for physical scale.

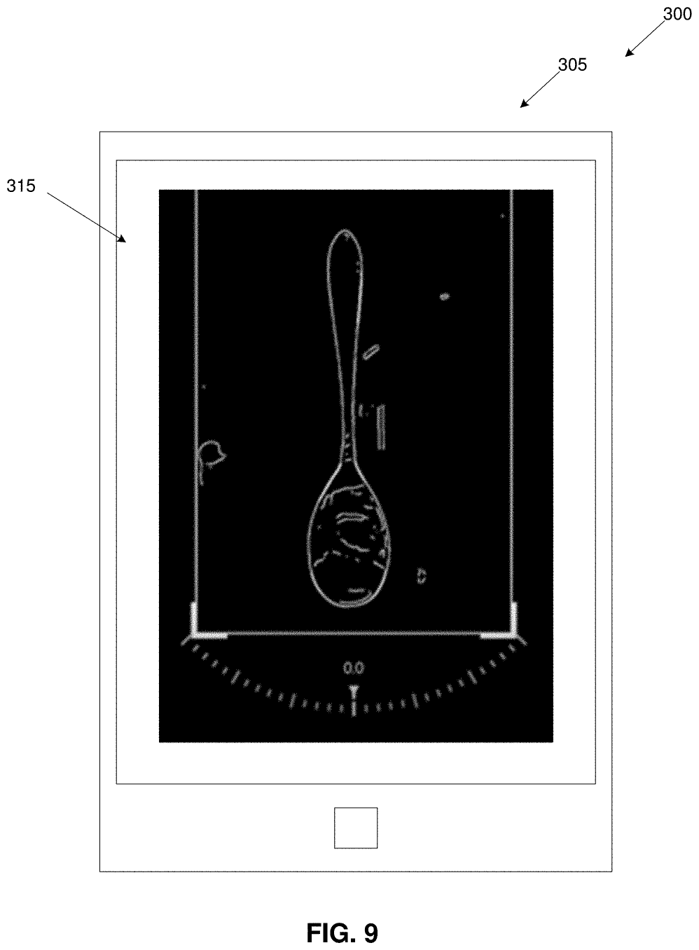

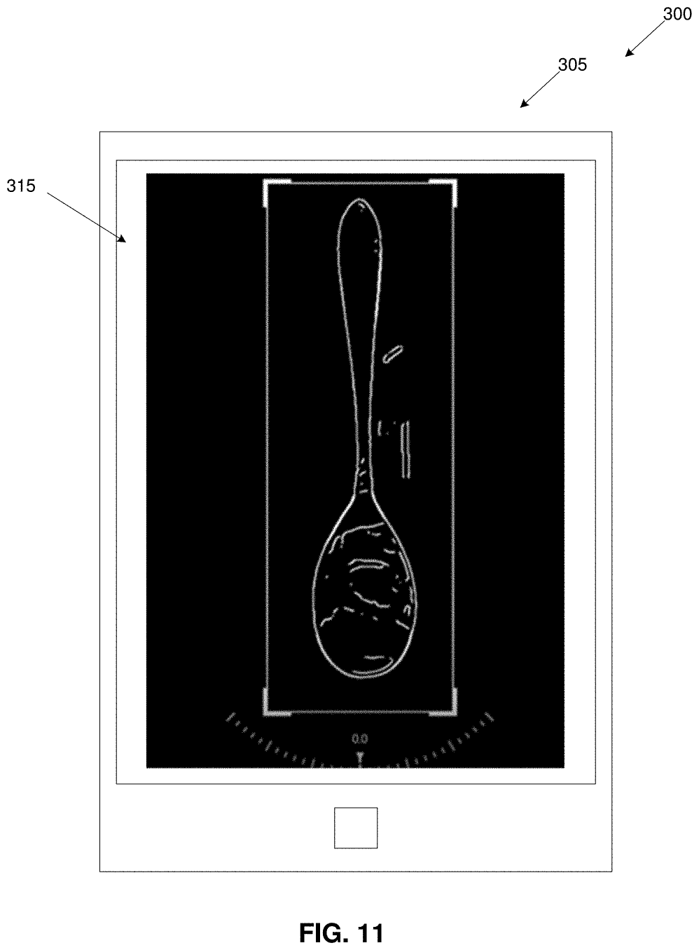

The scale module or system may also for example utilize computer vision systems (e.g., augmented reality) and/or sensed location or position data to identify and/or lead a user to position system 300 (e.g., a smartphone having an imaging system) to a suitable position (e.g., suitable conditions such as ideal conditions) that may allow for an accurate capture of a physical object and extraction of outlines matching a real-world scale of the object. For example, the scale module or system may utilize an augmented reality system combined with accelerometer data, e.g., based on an accelerometer 325 (e.g., or a gyroscope 325 or any other suitable orientation-sensing device) that may be included in user device 305 or any other suitable components that may sense and determine an orientation of user device 305. For example, the scale module or system may utilize augmented reality (e.g., as illustrated in FIGS. 9 and 11) and accelerometer 325 to determine an orientation of user device 305 that may be parallel to a surface (e.g., surface 322) of the object being imaged. For example, system 300 may determine the scale of the captured environment by using accelerometer 325 to sense an orientation of user device 305 and displaying instructions on a user interface (e.g., a screen) of user device 305 for adjusting the orientation of user device 305 to a target orientation.

The exemplary disclosed techniques may provide a scale that may be used by system 300 to measure actual dimensions of the imaged object (e.g., object 318). For example, system 300 may determine one or more dimensions of the imaged object based on the scale determined for example as described above. For example, system 300 may determine a dimension of edge contour 324 based on the scale determined for example as described above.

System 300 may also perform post-processing (e.g., involving a post-processing module or algorithm) of subsequent extracted scaled outlines of the objects. The post-processing may make adjustments and be configured to account for camera system shortcomings or defects (e.g., inherent defects) such a barrel roll and distortion. The post-processing may configure (e.g., bring) the scaled outlines extracted by system 300 to a suitable orthographic outline (e.g., as close to an orthographic outline as possible). The post-processing may utilize factors or features that may be similar to visual reference object 330 described above regarding the scale module or system. For example, the post-processing module or algorithm may utilize a calibration chart (e.g., a simplified calibration chart) that may be integrated into a visual reference object (e.g., similar to visual reference object 330) such as a printed QR code (e.g., to make adjustments based on predetermined characteristics of user device 305 and/or imaging system 320 such as barrel roll and distortion).

In at least some exemplary embodiments, the edge detection module, the exemplary disclosed scale module or algorithm, and/or the exemplary disclosed post-processing module or algorithm may exist or be integrated into a centralized system (e.g., AWS, Azure, GCP) or as decentralized processing on user devices (e.g., user device 305) such as individual mobile phones. For example, the various modules, systems, or algorithms of system 300 may be located or integrated into any desired components of system 300 such as user devices, cloud-computing or network components, and/or any other suitable component of system 300.

In at least some exemplary embodiments, the exemplary disclosed edge identification module may utilize machine learning (e.g., artificial intelligence operations) as disclosed for example below. The exemplary disclosed edge identification module may thereby utilize machine learning to identify edges of an object imaged or targeted by the exemplary disclosed system.

The exemplary disclosed system and method may be used in any suitable application for extracting outlines of physical objects. For example, the exemplary disclosed system and method may be used in any suitable application for scaling images of objects to real-world proportions.

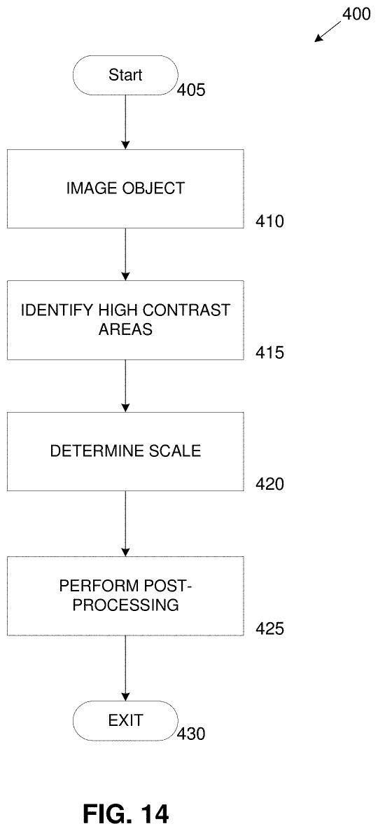

FIG. 14 illustrates an exemplary operation of system 300. Process 400 begins at step 405. System 300 may image an object at step 410 for example as described above (e.g., via a camera, laser scanning, and/or any other suitable technique). At step 415, system 300 may identify high contrast areas using the exemplary disclosed techniques for example as described above (e.g., regarding FIGS. 4-13). At step 420, system 300 may determine a scale for example as described above (e.g., via visual reference object 330, augmented reality using an accelerometer, and/or any other suitable technique). At step 425, system 300 may perform post-processing for example as described above. Process 400 ends at step 430.

In at least some exemplary embodiments, the exemplary disclosed method may include imaging an object and an environment in which the object is located, identifying a high contrast area at an edge of the object, isolating a contour of the object based on the high contrast area, determining a scale of the environment, and determining a dimension of the contour based on the scale. Isolating the contour may include isolating an edge contour of the object. Isolating the contour may include isolating a silhouette of the object. Imaging the object may include using a camera or a laser scanning device. Imaging the object may include using a smartphone camera or a LIDAR camera. Identifying the high contrast area at the edge of the object may include identifying a plurality of high contrast areas located at a plurality of edges of the object and a surface of the environment located behind the object. Isolating the contour may include determining graphical approximations of the plurality of high contrast areas. Identifying the high contrast area may include using a Canny edge detector or a Sobel operator. Imaging the object and the environment may include imaging a visual reference object of a predetermined size located in the environment. Determining the scale of the environment may include basing the scale on the imaged visual reference object. The exemplary disclosed method may include adjusting the determined dimension of the contour based on a calibration chart that is integrated into the visual reference object. The visual reference object may be a printed QR code. The exemplary disclosed method may further include imaging the object and the environment includes using a user device including an imaging device and an accelerometer, and determining the scale of the environment includes using the accelerometer to sense an orientation of the user device and displaying instructions on a user interface of the user device for adjusting the orientation of the user device to a target orientation.

In at least some exemplary embodiments, the exemplary disclosed system may include an object outlining module, comprising computer-executable code stored in non-volatile memory, a processor, and a user device including an imaging device. The object outlining module, the processor, and the user device may be configured to image an object and an environment in which the object is located, identify a high contrast area at an edge of the object, isolate an edge contour of the object based on the high contrast area, determine a scale of the environment, and determine a dimension of the edge contour based on the scale. The user device may be a smartphone and the imaging device may be a smartphone camera or a LIDAR camera disposed on a backside of the smartphone. The user device may include an accelerometer. The object outlining module, the processor, and the user device may be further configured to determine the scale of the environment using the accelerometer to sense an orientation of the user device and displaying instructions on a user interface of the user device for adjusting the orientation of the user device to a target orientation. The object outlining module, the processor, and the user device may be further configured to image a visual reference object of a predetermined size while imaging the object, and base the scale on the imaged visual reference object. The object outlining module, the processor, and the user device may be further configured to adjust the dimension of the edge contour based on a calibration chart that is integrated into the visual reference object. The visual reference object may be a printed QR code.

In at least some exemplary embodiments, the exemplary disclosed method may include imaging an object and an environment in which the object is located, identifying a high contrast area at an edge of the object and a surface of the environment located behind the object, isolating a silhouette of the object based on the high contrast area, determining a scale of the environment, and determining a dimension of the silhouette based on the scale. Imaging the object and the environment may include imaging a visual reference object of a predetermined size located in the environment. Determining the scale of the environment may include basing the scale on the imaged visual reference object. The exemplary disclosed method may further include adjusting the determined dimension of the silhouette based on a calibration chart that is integrated into the visual reference object. The visual reference object may be a printed QR code.

The exemplary disclosed system and method may provide an efficient and effective technique for extracting outlines of physical objects that may be accurate and scaled to real-world proportions.

An illustrative representation of a computing device appropriate for use with embodiments of the system of the present disclosure is shown in FIG. 15. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 16, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 16, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 16, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G, 5G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Turning now to FIG. 17, a continued schematic overview of a cloud-based system in accordance with an embodiment of the present invention is shown. In FIG. 17, the cloud-based system is shown as it may interact with users and other third party networks or APIs (e.g., APIs associated with the exemplary disclosed E-Ink displays). For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional data services 805 or any combination thereof. Additionally, application server 802 may be able to enhance or otherwise provide additional services to an external content provider API/website or other third party system 803, a constituent data service 804, one or more additional data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A method, comprising:
imaging an object and an environment in which the object is located;
identifying a high contrast area at an edge of the object;
isolating a contour of the object based on the high contrast area;
determining a scale of the environment; and
determining a dimension of the contour based on the scale.

2. The method of claim 1, wherein isolating the contour includes isolating an edge contour of the object.

3. The method of claim 1, wherein isolating the contour includes isolating a silhouette of the object.

4. The method of claim 1, wherein imaging the object includes using a camera or a laser scanning device.

5. The method of claim 1, wherein imaging the object includes using a smartphone camera or a LIDAR camera.

6. The method of claim 1, wherein identifying the high contrast area at the edge of the object includes identifying a plurality of high contrast areas located at a plurality of edges of the object and a surface of the environment located behind the object.

7. The method of claim 6, wherein isolating the contour includes determining graphical approximations of the plurality of high contrast areas.

8. The method of claim 1, wherein identifying the high contrast area includes using a Canny edge detector or a Sobel operator.

9. The method of claim 1, wherein:
imaging the object and the environment includes imaging a visual reference object of a predetermined size located in the environment; and
determining the scale of the environment includes basing the scale on the imaged visual reference object.

10. The method of claim 9, further comprising adjusting the determined dimension of the contour based on a calibration chart that is integrated into the visual reference object.

11. The method of claim 10, wherein the visual reference object is a printed QR code.

12. The method of claim 1, wherein:
imaging the object and the environment includes using a user device including an imaging device and an accelerometer; and
determining the scale of the environment includes using the accelerometer to sense an orientation of the user device and displaying instructions on a user interface of the user device for adjusting the orientation of the user device to a target orientation.

13. A system, comprising:
an object outlining module, comprising computer-executable code stored in non-volatile memory;
a processor; and
a user device including an imaging device;
wherein the object outlining module, the processor, and the user device are configured to:
image an object and an environment in which the object is located;
identify a high contrast area at an edge of the object;
isolate an edge contour of the object based on the high contrast area;
determine a scale of the environment; and
determine a dimension of the edge contour based on the scale.

14. The system of claim 13, wherein the user device is a smartphone and the imaging device is a smartphone camera or a LIDAR camera disposed on a backside of the smartphone.

15. The system of claim 13, wherein:
the user device includes an accelerometer; and
the object outlining module, the processor, and the user device are further configured to determine the scale of the environment using the accelerometer to sense an orientation of the user device and displaying instructions on a user interface of the user device for adjusting the orientation of the user device to a target orientation.

16. The system of claim 13, wherein the object outlining module, the processor, and the user device are further configured to:
image a visual reference object of a predetermined size while imaging the object; and
base the scale on the imaged visual reference object.

17. The system of claim 16, wherein:
the object outlining module, the processor, and the user device are further configured to adjust the dimension of the edge contour based on a calibration chart that is integrated into the visual reference object; and
the visual reference object is a printed QR code.

18. A method, comprising:
imaging an object and an environment in which the object is located;
identifying a high contrast area at an edge of the object and a surface of the environment located behind the object;
isolating a silhouette of the object based on the high contrast area;
determining a scale of the environment; and
determining a dimension of the silhouette based on the scale.

19. The method of claim 18, wherein:
imaging the object and the environment includes imaging a visual reference object of a predetermined size located in the environment; and
determining the scale of the environment includes basing the scale on the imaged visual reference object.

20. The method of claim 19, further comprising adjusting the determined dimension of the silhouette based on a calibration chart that is integrated into the visual reference object;
wherein the visual reference object is a printed QR code.
